(19) United States
(12) Patent Application Publication
(10) Pub. No.: US 2007/0099013 A1
(43) Pub. Date: May 3, 2007

(54) Methods and apparatus for manufacturing a component

(75) Inventors: Raymond Grant Rowe, Niskayuna, NY (US); Robert Scott Shalvoy, Scotia, NY (US); Warren Arthur Nelson, Clifton Park, NY (US)

Correspondence Address: JOHN S. BEULICK (17851), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/260,813

(22) Filed: Oct. 27, 2005

(51) Int. Cl. B05D 3/02; B05D 1/36; B05D 1/08; B32B 15/04

(52) U.S. Cl. 428/469; 427/402; 427/372.2; 427/446

(57) ABSTRACT

A method for manufacturing a machine component is provided. The method includes forming a machine component substrate wherein the substrate has a substrate surface region. The method further includes forming at least one primary thermal barrier layer including a first ceramic thermal barrier material having a first porosity. The method also includes forming at least one secondary thermal barrier layer formed over at least a portion of the plurality of primary thermal barrier layers. Also, the secondary thermal barrier layer further includes a second ceramic thermal barrier material having a second porosity that is greater than the first porosity. The method also includes forming at least one tertiary thermal barrier layer comprising a smooth coat material, wherein the tertiary thermal barrier layer is formed over at least a portion of the secondary thermal barrier layer. The secondary thermal barrier layer facilitates reducing a delamination of the tertiary thermal barrier layer.

### BACKGROUND OF THE INVENTION

This invention relates generally to ceramic coating layers and more particularly, to dense, vertically cracked thermal barrier coating layers.

In some known gas turbine engines, some components such as bucket airfoils, may be subjected to high temperature conditions in excess of 1000 degrees Celsius (° C.) (1832 degrees Fahrenheit (° F.)) when in service. In order to protect these components, a ceramic thermal barrier coating (TBC) layer may be used to provide an effective and reliable thermally insulating barrier between the base metal, or ceramic, substrate of the components and high temperature environments. As is known in the art, the smoothness of the coating may affect the aerodynamic properties of the surface as well as facilitate reducing heat transfer coefficient.

In some known components, a TBC layer is formed by a plasma spray process to achieve desired structural characteristics, i.e., mechanical and thermal properties. A typical plasma spray process may involve use of a plasma spray torch, or nozzle, that produces hot ionized plasma for melting TBC powder injected therein.

One known TBC layer deposition is often referred to as a dense, vertically cracked (DVC) material. DVC TBC materials tend to have a dense microstructure having an accompanying low porosity that facilitates increased erosion resistance. DVC TBC materials also have a plurality of vertical micro-cracks that facilitate increased strain tolerance. However, the high densities and low porosities may tend to increase the difficulty associated with smoothing the surfaces of components that have received a DVC TBC layer.

Some known component manufacturing processes involve use of some known “smooth coat” ceramic TBC materials to form a layer on the components subsequent to the DVC TBC application. At least some of such smooth coat materials produce smooth surfaces on porous thermal barrier coatings. However, some of these smooth coat materials typically may not adhere reliably to DVC TBC. As a result, the smooth coat layer may “spall” (i.e., delaminate, or lift off) from the component surface during curing, thereby damaging the component prior to completion of manufacturing.

### BRIEF DESCRIPTION OF THE INVENTION

In one aspect, a method for manufacturing a machine component is provided. The method includes forming a machine component substrate wherein the substrate has a substrate surface region. The method further includes forming at least one primary thermal barrier layer wherein the at least one primary thermal barrier layer includes a first primary thermal barrier layer. The first primary thermal barrier layer further includes a first ceramic thermal barrier material having a first porosity. The method also includes forming at least one secondary thermal barrier layer wherein the at least one secondary thermal barrier layer is formed over at least a portion of the first primary thermal barrier layer. Also, the secondary thermal barrier layer further includes a second ceramic thermal barrier material having a second porosity, wherein the second porosity is greater than the first porosity. The method also includes forming at least one tertiary thermal barrier layer comprising a smooth coat material having a tertiary porosity, wherein the tertiary thermal barrier layer is formed over at least a portion of the secondary thermal barrier layer. The secondary thermal barrier layer facilitates reducing a delamination of the tertiary thermal barrier layer. The method further includes curing the tertiary thermal barrier layer.

In another aspect, a method for manufacturing a turbine component having a thermal barrier coating is provided. The method includes forming a turbine component substrate wherein the substrate has a substrate surface region. The method further includes forming at least one primary thermal barrier layer using a spray nozzle positioned a first distance from the component. The forming of the primary thermal barrier layers include the formation of a first primary thermal barrier layer over at least a portion of the substrate surface region of the machine component. At least one subsequent primary thermal barrier layer extends substantially over each previously formed primary thermal barrier layer. The plurality of primary thermal barrier layers include a first ceramic thermal barrier material having a first porosity. The method also includes forming at least one secondary thermal barrier layer using a spray nozzle positioned a second distance from the component wherein the second distance is greater than the first distance. The secondary thermal barrier layer is formed over at least a portion of the primary thermal barrier layers. Furthermore, the secondary thermal barrier layer includes a second ceramic thermal barrier material having a second porosity that is greater than the first porosity. The method also includes forming at least one tertiary thermal barrier layer that includes a smooth coat material having a tertiary porosity. The tertiary thermal barrier layer is formed over at least a portion of the at least one secondary thermal barrier layer. The method further includes curing the tertiary thermal barrier layer in air at a predetermined temperature wherein the secondary thermal barrier layer facilitates reducing a delamination of the tertiary thermal barrier layer.

In a further aspect, a machine component is provided. The machine component includes a substrate comprised of a surface region wherein the substrate further includes an article having predetermined dimensions. The component also includes at least one primary thermal barrier layer that has a first porosity. The component further includes at least one secondary thermal barrier layer that has a second porosity, wherein the second porosity is greater than the first porosity. The component also includes at least one tertiary thermal barrier layer having a tertiary porosity, wherein the second porosity facilitates reducing a delamination of the at least one tertiary thermal barrier layer.

### BRIEF DESCRIPTION OF THE DRAWINGS

FIG. 1 is a fragmentary schematic illustration of a cross-section of an exemplary turbine component; and

FIG. 2 is a flow chart of an exemplary method for manufacturing the turbine component in FIG. 1.

### DETAILED DESCRIPTION OF THE INVENTION

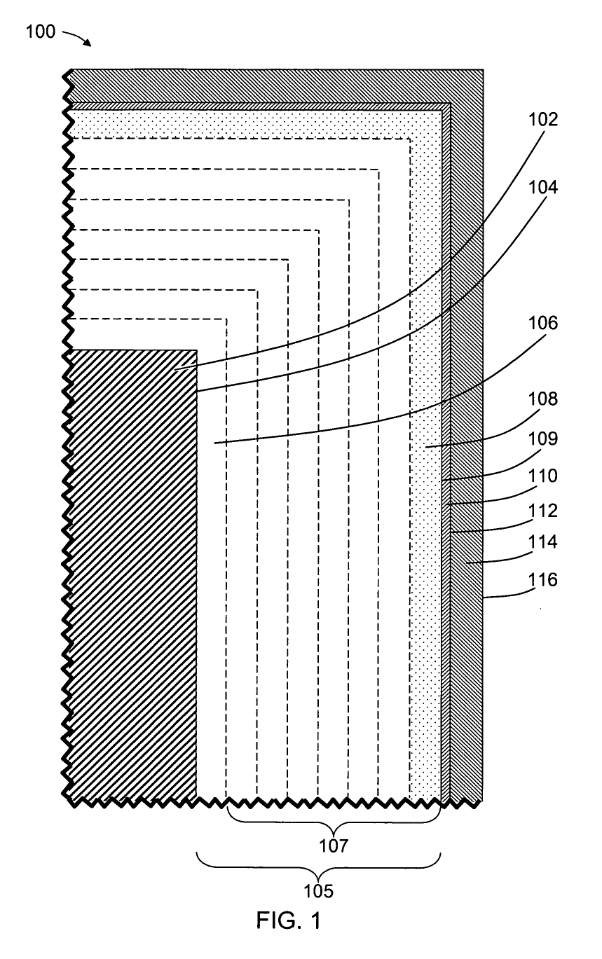

FIG. 1 is a fragmentary schematic illustration of a cross-section of an exemplary turbine component 100. Turbine component 100 includes a substrate 102 that further includes a substrate surface region 104. Component 100 also includes at least one primary dense vertically cracked (DVC) thermal barrier coating (TBC) layer 105 that further includes a first DVC TBC layer 106 and a plurality of subsequent DVC TBC layers 107. Layers 107 includes a circumferential outermost DVC TBC layer 108 and a circumferentially outermost DVC TBC layer surface 109. Component 100 further includes a secondary TBC layer 110 having a circumferentially outermost secondary TBC layer surface 112 and a tertiary TBC layer 114 having a circumferentially outermost tertiary TBC layer surface 116.

As used herein, the term layer refers to, but is not limited to, a sheet-like expanse or region of a material or materials covering a surface, or forming an overlying or underlying part or segment of an article such as a turbine component. A layer has a thickness dimension. The term layer does not refer to any particular process by which the layer is formed. For example, a layer can be formed by spraying, coating, or a laminating process.

Substrate 102 includes surface region 104 and may be shaped with predetermined dimensions to a set of predetermined contours and thicknesses substantially similar to the dimensions of finished turbine component 100. In the exemplary embodiment, substrate 102 may be metallic. Alternatively, substrate 102 may be ceramic.

In the exemplary embodiment DVC TBC layers 105 includes eight (8) layers with first DVC TBC layer 106 formed over surface region 104, and seven (7) subsequent DVC TBC layers 107, each subsequent layer formed over a previous layer. The thickness and porosity of each layer are substantially similar. The thickness of each of plurality of layers 105 is approximately 0.0508 millimeters (mm) (0.002 inches) each for a total thickness of approximately 0.4064 mm (0.016 inches). Circumferentially outermost surface 109 of layer 108 may be smoothed. DVC TBC layers 105 may be a metal oxide material, such as yttria-stabilized zirconia having a chemical composition of 6-8 weight percent yttria with a balance of zirconia. Alternately, DVC TBC layers 105 may include other ceramic materials and the associated number of layers and the thicknesses of these layers may be varied according to appropriate standards and tolerances. In the exemplary embodiment, one secondary TBC layer 110 is formed over circumferentially outermost DVC TBC layer surface 108. Layer 110 is a layer that is less dense, i.e., more porous, than DVC TBC layers 105.

In the exemplary embodiment, one tertiary TBC layer 114 is formed over surface 112. Layer 114 is approximately 0.0254 mm (0.001 inches) to 0.0508 mm (0.002 inches). In the exemplary embodiment a smooth coat material is used, such as, but not limited to, AJ11. In the exemplary embodiment, one layer with the thickness described above is formed with a surface roughness that may be approximately less than 2.54 micrometers (100 micro-inches) roughness average (RA). Alternatively, the number of layers and the thickness of the layers may be varied according to the component's 100 operational application.

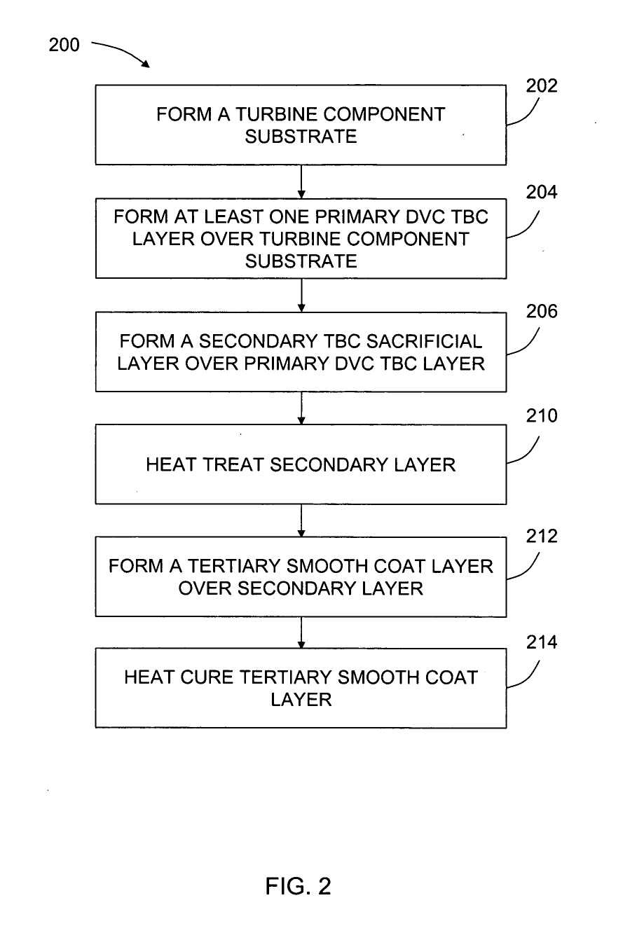

FIG. 2 is a flow chart of an exemplary method 200 for manufacturing turbine component 100 (shown in FIG. 1). Method 200 includes forming 202 a turbine component substrate 102 (shown in FIG. 1) wherein substrate 102 has a substrate surface region 104 (shown in FIG. 1), shaped with predetermined dimensions to a set of predetermined contours and thicknesses substantially similar to the dimensions of a finished machine component. In the exemplary embodiment, a metallic component substrate 102 may be formed via pouring molten metal into a casting having a substantially similar shape of component substrate 102 and allowed to cool. A metallic material selected to form component substrate 102 may be determined based on the particular component desired to be formed and its subsequent operational application. The primary interface for the subsequent layer is surface 104 of metallic component substrate 102.

Method 200 includes a method step 204 that further includes forming at least one primary DVC TBC layer 105 (shown in FIG. 1) on turbine component 102. In general, dense vertically cracked (DVC) layers are formed by plasma-spraying a plurality of layers of TBC on surface 104 of turbine component 102. A layer of ceramic material may be deposited in a given plane or unit of area during one pass of a plasma-spray torch (not shown in FIG. 1 or 2). In order to substantially completely cover surface 104 of substrate 102 and obtain the necessary thickness of a TBC layer, it is generally desirable that the plasma-spray torch and substrate 102 be moved in relation to one another when depositing the TBC layer. This can take the form of moving the torch, substrate 102, or both, and is analogous to processes used for spray painting. This motion, combined with the fact that a given plasma-spray torch sprays a pattern which covers a finite area (i.e., has a torch footprint), results in the TBC being deposited in layers.

In the exemplary embodiment DVC TBC layers 105 may be deposited with eight (8) spray passes with the torch or nozzle located a distance of approximately 11.43 centimeters (cm) (4.5 inches) from substrate surface 104, using a computer-controlled program with robotic motion for reproducibility. The thickness and porosity of each of layers 105 are substantially similar. This process produces a uniformly hard, dense, ceramic coating, adding about 0.0508 millimeters (mm) (0.002 inches) per pass for a total thickness of approximately 0.4064 mm (0.016 inches). In the exemplary embodiment, surface 109 is not smoothed. In an alternative embodiment, the aforementioned total thickness allows for approximately 0.0508 mm (0.002 inches) to be removed during finishing operations of layer 108 (shown in FIG. 1) that may be used to achieve the desired surface 109 roughness and thickness specifications. Also, alternately, the number of passes, the torch-to-component distance, the thickness deposition per pass and the overall deposition thickness may be varied to facilitate the desired layer features on the component.

The ceramic material used to form plurality of DVC TBC layers 105 may be a metal oxide, such as yttria-stabilized zirconia having a chemical composition of 6-8 weight percent yttria with a balance of zirconia. Alternately, other ceramic materials may also be used.

In the exemplary embodiment, method 200 includes a method step 206 that further includes forming one secondary TBC layer 110 (shown in FIG. 1) on turbine component 100 wherein at least one additional pass of the plasma-spray torch is conducted, using parameters and motions substantially similar to the prior passes, with the exception that the pass is made from a distance of about 33 cm (13 inches) to 38.1 cm (15 inches). This added distance creates a “sacrificial” layer 110 of the TBC that is less dense, i.e., more porous, such that sacrificial layer 110 is softer and facilitates smoothing. Removal of relatively soft sacrificial layer 110 may be accomplished with conventional surface finishing materials, tools, techniques and processes with less time and resources applied than would be applied to remove the same thickness of denser DVC layer 108. Smoothing of sacrificial layer 110 reduces efforts to smooth denser DVC layer 108 and provides a “self-alarming” feature to a finishing operator. The change in hardness, as reflected in the level of effort desired to remove soft layer 110 versus harder layer 108, immediately alerts the operator that soft layer 110 is depleted and adjacent hard layer 108 is now being worked. Thus, the approach should minimize the potential for “overblending”, i.e., removal of too much of DVC TBC layer 108 during finishing, possibly resulting in a DVC TBC layer thickness that may be under a predetermined minimum thickness tolerance. Alternatively, the number of passes, the number of layers and the thicknesses of these layers may be varied according to appropriate standards and tolerances. Also, in the exemplary embodiment, the porosity of the secondary layers may be adjusted in a plurality of methods including, but not limited to, adjusting the distance of the associated plasma torch passes, the chemical composition of the associated TBC material and/or adjusting the temperature of the plasma spray process.

A method step 210 of exemplary method 200 includes applying a high temperature heat treatment to component 100. The associated heat treatment temperatures and time periods may vary based on a plurality of parameters that may include, but not be limited to, the number of layers and the predetermined thicknesses of the layers.

A method step 212 of exemplary method 200 includes forming a tertiary TBC layer 114 (shown in FIG. 1) of approximately 0.0254 mm (0.001 inches) to 0.0508 mm (0.002 inches) on turbine component 100 via spraying component 100 with a smooth coat slurry (not shown in FIG. 1 or 2) for a predetermined period of time. The more porous surface 112 of secondary TBC layer 110 allows the smooth coat slurry to interpenetrate during application and facilitates an improvement in the adherence of tertiary layer 114 to the secondary TBC layer 110. In the exemplary embodiment, one layer with the thickness described above is formed with a surface roughness that may be approximately less than 2.54 micrometers (100 micro-inches) roughness average (RA). Alternatively, the number of layers and the thicknesses of these layers may be varied according to appropriate standards and tolerances.

A method step 214 of exemplary method 200 includes heat curing component 100 in air at a temperature of approximately 900° C. (1650° F.). This step is a test in that heating the component induces stresses that may delaminate tertiary layer 114 from secondary layer 110 if the adherence of layer 114 to layer 110 is not sufficient. The associated heat curing temperatures and time periods may vary based on a plurality of parameters that may include, but not be limited to, the number of layers and the predetermined thicknesses of the layers.

The component manufacturing methods described herein facilitate application of a protective thermal barrier layer to a component. More specifically, forming a plurality of protective layers on the turbine component described above prevents damage in high temperature environments. As a result, degradation of the component when placed in service and increased manufacturing costs may be reduced or eliminated.

Although the methods described and/or illustrated herein are described and/or illustrated with respect to manufacturing a component, and more specifically, a turbine component, practice of the methods described and/or illustrated herein is not limited to turbine components nor to forming thermal barrier layers generally. Rather, the methods described and/or illustrated herein are applicable to manufacturing any article and forming any layer of any material.

Exemplary embodiments of turbine component manufacturing are described above in detail. The methods, apparatus and systems are not limited to the specific embodiments described herein nor to the specific turbine components manufactured, but rather, the methods of manufacturing turbine components may be utilized independently and separately from other methods, apparatus and systems described herein or to manufacturing components not described herein. For example, other components can also be manufactured using the methods described herein.

While the invention has been described in terms of various specific embodiments, those skilled in the art will recognize that the invention can be practiced with modification within the spirit and scope of the claims.

What is claimed is:

1. A method for manufacturing a machine component, said method comprising:
forming a machine component substrate wherein the substrate has a substrate surface region;
forming at least one primary thermal barrier layer wherein the at least one primary thermal barrier layer comprises a first primary thermal barrier layer formed over at least a portion of the substrate surface region of the machine component, wherein the primary thermal barrier layer includes a first ceramic thermal barrier material having a first porosity;
forming at least one secondary thermal barrier layer wherein the at least one secondary thermal barrier layer is formed over at least a portion of the primary thermal barrier layer, the secondary thermal barrier layer further comprising a second ceramic thermal barrier material having a second porosity, the second porosity being greater than the first porosity;
forming at least one tertiary thermal barrier layer comprising a smooth coat material having a tertiary porosity, wherein the at least one tertiary thermal barrier layer is formed over at least a portion of the secondary thermal barrier layer, the secondary thermal barrier layer facilitating reducing a delamination of the tertiary thermal barrier layer; and
curing the tertiary thermal barrier layer.

2. A method in accordance with claim 1 wherein forming at least one primary thermal barrier layer comprises spraying the first ceramic thermal barrier material over the at least a portion of the substrate surface region of the machine component.

3. A method in accordance with claim 2 wherein spraying the first ceramic thermal barrier material over the at least a portion of the substrate surface region of the machine component comprises spraying the primary thermal barrier layer such that a thickness and a porosity of each of the primary thermal barrier layers are substantially similar.

4. A method in accordance with claim 1 wherein forming at least one primary thermal barrier layer further comprises spraying the primary thermal barrier layer at a first distance from the component.

5. A method in accordance with claim 1 wherein forming at least one secondary thermal barrier layer comprises spraying the secondary thermal barrier layer having a predetermined thickness at a second distance from the component wherein the second distance is greater than the first distance.

6. A method in accordance with claim 1 wherein forming at least one secondary thermal barrier layer comprises adjusting a chemical composition of the second ceramic thermal barrier material such that it is substantially similar to the chemical composition of the first ceramic thermal barrier material.

7. A method in accordance with claim 1 wherein forming at least one tertiary thermal barrier layer comprises spraying at least a portion of the component with a smooth coat material slurry.

8. A method in accordance with claim 1 wherein curing the tertiary thermal barrier layer comprises curing the tertiary thermal barrier layer in the air at a predetermined temperature.

9. A method for manufacturing a turbine component having a thermal barrier coating, said method comprising:
forming a turbine component substrate wherein the substrate has a substrate surface region;
forming at least one primary thermal barrier layer using a spray nozzle positioned a first distance from the component, wherein the at least one primary thermal barrier layer comprises a first primary thermal barrier layer formed over at least a portion of the substrate surface region of the machine component and at least one subsequent primary thermal barrier layer, wherein each subsequent primary thermal barrier layer extends substantially over each previously formed primary thermal barrier layer; the primary thermal barrier layers further comprising a first ceramic thermal barrier material having a first porosity;
forming at least one secondary thermal barrier layer using a spray nozzle positioned a second distance from the component, wherein the second distance is greater than the first distance, the secondary thermal barrier layer being formed over at least a portion of the at least one primary thermal barrier layers, the secondary thermal barrier layer further comprises a second ceramic thermal barrier material having a second porosity, the second porosity being greater than the first porosity;
forming at least one tertiary thermal barrier layer comprising spraying the component with a smooth coat material slurry having a tertiary porosity, wherein the tertiary thermal barrier layer is formed over at least a portion of the secondary thermal barrier layer, the secondary thermal barrier layer facilitating reducing a delamination of the tertiary thermal barrier layer; and
curing the tertiary thermal barrier layer in air at a predetermined temperature.

10. A method in accordance with claim 9 wherein forming at least one primary thermal barrier layer comprises depositing the first ceramic thermal barrier material via plasma spraying the component such that a predetermined thickness and a predetermined chemical composition of each of the of the layers are substantially similar.

11. A method in accordance with claim 9 wherein forming the at least one secondary thermal layer comprises depositing the second ceramic thermal barrier material having a predetermined thickness via plasma spraying the component.

12. A method in accordance with claim 9 wherein forming at least one secondary layer comprises depositing the secondary layer via plasma spraying the second thermal barrier material having a chemical composition substantially similar to the chemical composition of the first ceramic thermal barrier material.

13. A method in accordance with claim 9 wherein forming at least one tertiary thermal barrier layer comprises spraying at least a portion of the component with a smooth coat material slurry, said tertiary thermal barrier layer comprises a tertiary chemical composition and a predetermined thickness.

14. A method in accordance with claim 9 wherein curing the at least one tertiary thermal barrier layer comprises curing the tertiary thermal barrier layer in air at a predetermined temperature for a predetermined period of time.

15. A machine component comprising:
a substrate comprised of a surface region wherein said substrate further comprises an article having predetermined dimensions;
at least one primary thermal barrier layer comprised of a first porosity;
at least one secondary thermal barrier layer comprised of a second porosity wherein said second porosity is greater than said first porosity; and
at least one tertiary thermal barrier layer wherein said second porosity facilitates reducing a delamination of said at least one tertiary thermal barrier layer.

16. A machine component in accordance with claim 15 wherein said article having predetermined dimensions comprises an article pre-shaped to a set of predetermined contours and thicknesses substantially similar to the dimensions of a finished machine component.

17. A machine component in accordance with claim 15 wherein said at least one primary thermal barrier layer comprises a first primary thermal barrier layer and at least one subsequent primary thermal barrier layer, said primary thermal barrier layers further comprising a first ceramic thermal barrier material having a first chemical composition, a plurality of predetermined thicknesses and a plurality of porosities.

18. A machine component in accordance with claim 15 wherein said thicknesses and said porosities of each of said primary thermal barrier layers comprise substantially similar thicknesses and substantially similar porosities.

19. A machine component in accordance with claim 15 wherein said at least one secondary thermal barrier layer comprises a second ceramic thermal barrier material having a second chemical composition and a predetermined thickness, wherein said second chemical composition is substantially similar to said first chemical composition.

20. A machine component in accordance with claim 15 wherein said at least one tertiary thermal barrier layer comprises a smooth coat material having a predetermined thickness.
